(19) United States
(12) Patent Application Publication
(10) Pub. No.: US 2024/0396089 A1
(43) Pub. Date: Nov. 28, 2024

(54) Non-Aqueous Fluorinated Electrolytes for Lithium Batteries

(71) Applicant: UCHICAGO ARGONNE, LLC, Chicago, IL (US)

(72) Inventors: Chi Cheung SU, Westmont, IL (US); Khalil AMINE, Oakbrook, IL (US)

(73) Assignee: UCHICAGO ARGONNE, LLC, Chicago, IL (US)

(21) Appl. No.: 18/200,059

(22) Filed: May 22, 2023

(51) Int. Cl. H01M 10/0569

(52) U.S. Cl. CPC H01M 10/0569; H01M 2300/0034; H01M 2300/0037

(57) ABSTRACT

An electrochemical cell includes a cathode comprising a cathode active material, an anode comprising an anode active material, and an electrolyte comprising a sulfonyl solvent, a terminally fluorinated glycol ether, and a salt. Other electrochemical cells include a cathode, an anode, a separator, and an electrolyte comprising: a lithium salt; a cathode stabilizing additive selected from the group consisting of vinylene carbonate, vinyl ethylene carbonate, LiBF₂(C₂O₄), LiB(C₂O₄)₂, LiPF₂(C₂O₄)₂, LiPF₄(C₂O₄), LiPF₆, LiAsF₆, CsF, CsPF₆, Li₂(B₁₂X₁₂₋ᵢHᵢ), Li₂(B₁₀X_{10-i′}H_{i′}), or a mixture of any two or more thereof, wherein the cathode stabilizing additive is not the same as the lithium salt, wherein each X is independently at each occurrence a halogen, i is an integer from 0 to 12 and i′ is an integer from 0 to 10; and a fluorinated organosulfate compound.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The technology generally relates to lithium rechargeable batteries. More particularly the technology relates to the use of short-chain terminally fluorinated glycol ethers and organosulfur solvents in an electrochemical cell.

### SUMMARY

In one aspect, an electrochemical cell includes a cathode comprising a cathode active material; an anode comprising an anode active material; and an electrolyte comprising a sulfonyl solvent, a terminally fluorinated glycol ether, and a salt. In some embodiments, the terminally fluorinated glycol ether is represented by Formula I:

R¹(O(CH₂)ₘ)ₓ(O(CH₂)ₙ)_{y}OR² (I).

In Formula I, R¹ is a fluorinated alkyl; R² is a fluorinated alkyl; m is 1, 2, or 3; n is 1, 2, or 3; and x and y are each independently 0, 1, or 2, with the provisos that both x and y are not 0 and x+y≤3. In some embodiments, R¹ and R² are individually —(CH₂)_{q}(CR⁴R⁵)ₚC(R³)₃, where R³, R⁴, and R⁵ are each independently H or F, with the proviso that at least one of R³, R⁴, and R⁵ is F; q is 0, 1, 2, or 3; and p is 0, 1, 2, 3, 4, 5, or 6.

In any of the above embodiments, the sulfonyl solvent includes a compound represented by Formula (II):

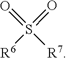

In Formula (II), R⁶ is H, F, Cl, Br, I, OR⁸, NR⁹R¹⁰, alkyl, alkenyl, alkynyl, silyl, siloxy, aryl, aralkyl, heterocyclyl, heterocyclylalkyl, cycloalkyl, cycloalkylalkyl, —C(O)R¹¹, —C(O)OR¹¹, or —OC(O)R¹¹, wherein any of the alkyl, alkenyl, alkynyl, silyl, siloxy, aryl, aralkyl, heterocyclyl, heterocyclylalkyl, cycloalkyl, and cycloalkylalkyl may be substituted or unsubstituted; R⁷ is H, F, Cl, Br, I, OR⁸, NR⁹R¹⁰, alkyl, alkenyl, alkynyl, silyl, siloxy, aryl, aralkyl, heterocyclyl, heterocyclylalkyl, cycloalkyl, cycloalkylalkyl, —C(O)R¹¹, —C(O)OR¹¹, or —OC(O)R¹¹, wherein any of the alkyl, alkenyl, alkynyl, silyl, siloxy, aryl, aralkyl, heterocyclyl, heterocyclylalkyl, cycloalkyl, and cycloalkylalkyl may be substituted or unsubstituted; or R⁶ and R⁷ join together and form a cyclic structure that includes the sulfur atom to which they are bound; R⁸ is H or alkyl; R⁹ is H or alkyl; R¹⁰ is H or alkyl; and R¹¹ is H or alkyl. In some embodiments, R⁶ is C₁-C₈ alkyl, OR⁸, or NR⁹R¹⁰, and R⁷ is C₁-C₈ alkyl, OR⁸, or NR⁹R¹⁰. In other embodiments, R⁶ is C₁-C₈ alkyl, OR⁸, or NR⁹R¹⁰, and R⁷ is NR⁹R¹⁰. In further embodiments, R⁶ and R⁷ join together for form a cyclic structure that includes the sulfur atom to which they are bound.

In another aspect, an electrochemical cell includes a cathode; an anode; a separator; and an electrolyte that includes a lithium salt; a cathode stabilizing additive selected from the group consisting of vinylene carbonate, vinyl ethylene carbonate, LiBF₂(C₂O₄), LiB(C₂O₄)₂, LiPF₂(C₂O₄)₂, LiPF₄(C₂O₄), LiPF₆, LiAsF₆, CsF, CsPF₆, Li₂(B₁₂X₁₂₋ᵢHᵢ), Li₂(B₁₀X_{10-i′}H_{i′}), or a mixture of any two or more thereof, wherein the cathode stabilizing additive is not the same as the lithium salt, or where appropriate is not the same as the electrolye stabilizing additive, wherein each X is independently at each occurrence a halogen, i is an integer from 0 to 12 and i′ is an integer from 0 to 10; and a fluorinated organosulfate compound represented by Formula II:

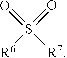

In Formula (II), R⁶ is OR^{8′}; R⁷ is OR^{8′}; R⁸ is alkyl, alkenyl, alkynyl, aralkyl, or silyl, each of which may be substituted with one or more F; R^{8′} is alkyl, alkenyl, alkynyl, aralkyl, or silyl, each of which may be substituted with one or more F; or R⁸ and R^{8′} join together and form a cyclic structure that includes the sulfur atom; with the proviso that at least one of R⁸ and R^{8′} is substituted with one or more F. In some embodiments, R⁸ and R^{8′} are individually C₁-C₈ alkyl. In other embodiments, R⁸ and R^{8′} form a group of formula —C(R¹²)(R¹³)C(R¹⁴)(R¹⁵)—; R¹², R¹³, R¹⁴, and R¹⁵ are individually H, F, OR¹⁶, alkyl, alkenyl, aralkyl, silyl, an ether, —C(O)OR¹⁶, —OC(O)R¹⁶; each R¹⁶ is H, alkyl, alkenyl, aralkyl; or silyl; or wherein R¹² and R¹³ or R¹⁴ and R¹⁵ join together to form an ═O group; and at least one R¹², R¹³, R¹⁴, and R¹⁵ is fluorine or is a fluorinated group.

In any of the above embodiments, the electrochemical cell may also include a terminally fluorinated glycol ether represented by Formula I:

R¹(O(CH₂)ₘ)ₓ(O(CH₂)ₙ)_{y}OR² (I).

In Formula I, R¹ is a fluorinated alkyl; R² is a fluorinated alkyl; m is 1, 2, or 3; n is 1, 2, or 3; and x and y are each independently 0, 1, or 2, with the provisos that both x and y are not 0 and x+y≤3. In some embodiments, R¹ and R² are individually —(CH₂)_{q}(CR⁴R⁵)ₚC(R³)₃, where R³, R⁴, and R⁵ are each independently H or F, with the proviso that at least one of R³, R⁴, and R⁵ is F; q is 0, 1, 2, or 3; and p is 0, 1, 2, 3, 4, 5, or 6.

### BRIEF DESCRIPTION OF THE DRAWINGS

FIG. 1 is a graph the voltage profiles for cells having an electrolyte of A) LiFSI:EMS:DG 2:4:1 (molar ratio); and B. LiFSI:EMS:FDG 2:4:1 (molar ratio), according to Example 1.

FIG. 2 is a voltage profile graph for cells prepared with electrolytes of LiFSI:EMS:TTE 2:4:1 (molar ratio) and LiFSI:EMS:FDG 2:4:1 (molar ratio), according to Example 1.

FIG. 3 is a discharge capacity vs. cycle number graph for a graphite∥LiNi_{0.8}Mn_{0.1}Co_{0.1}O₂ (NMC811) 2032 coin cells using electrolytes of LiFSI:EMS:TTE 2:4:1 (molar ratio), and LiFSI:EMS:FDG 2:4:1 (molar ratio), where the cells were cycled from 3.0 V to 4.25 V at a rate of C/2, according to Example 1.

FIG. 4 is a discharge capacity vs. cycle number graph for graphite∥NMC811 2032 coin cells using electrolytes of LiFSI:TFPMS 1:4 (molar ratio) and LiFSI:EMS 1:4 (molar ratio), where the cells were cycled from 3.0 V to 4.25 V at a rate of C/2, according to Example 2.

FIG. 5 is a voltage profile graph for cells prepared with electrolytes of LiFSI:TFPMS:TTE 1:4:2 (molar ratio) and LiFSI:TFPMS:FDG 1:4:2 (molar ratio), according to Example 3.

FIG. 6 is a discharge capacity vs. cycle number graph for graphite∥NMC811 2032 coin cells using electrolytes of LiFSI:TFPMS:TTE 1:4:2 (molar ratio) and LiFSI:TFPMS:FDG 1:4:2 (molar ratio), where the cells were cycled from 3.0 V to 4.25 V at a rate of C/2, according to Example 3.

FIG. 7 is a discharge capacity vs. cycle number graph for Graphite∥LiNi_{0.8}Mn_{0.1}Co_{0.1}O₂ full-cell in the 2032 coin cells using 1.2M LiFSI in EMS electrolyte, and 1.2M LiFSI in TMS electrolyte, where the cells were cycled from 3.0 V to 4.5 V at the rate of C/2, according to Example 4.

FIG. 8 is a discharge capacity vs. cycle number graph for Graphite∥LiNi_{0.8}Mn_{0.1}Co_{0.1}O₂ full-cell in the 2032 coin cells using 1.2M LiFSI in EMS electrolyte, 1.2M LiFSI in EMS with 2% VC electrolyte, 1.2M LiFSI in EMS with 2% DTD electrolyte, and 1.2M LiFSI in EMS with 2% TFDTD electrolyte, where the cells were cycled from 3.0 V to 4.5 V at the rate of C/2, according to Example 5.

FIG. 9A is a discharge capacity vs. cycle number graph and FIG. 9B is the corresponding Coulombic efficiency vs. cycle number graph for Graphite∥LiNi_{0.8}Mn_{0.1}Co_{0.1}O₂ full-cell in the 2032 coin cells using 1.2M LiPF₆ in EC/EMC 3/7 electrolyte, 1.2M LiFSI in EMS with 2% VC electrolyte, 1.2M LiFSI in EMS with 2% TFDTD electrolyte, and 1.2M LiFSI in EMS with 2% VC and 2% TFDTD electrolyte, where the cells were cycled from 3.0 V to 4.5 V at the rate of C/2, according to Example 6.

FIG. 10 shows linear sweep voltammograms of Li∥Al half-cells in the 2032 coin cells 1.2M LiFSI in EMS electrolyte, 1.2M LiFSI in EMS with 2% TFDTD electrolyte, 1.2M LiFSI in EMS with 2% TFDTD electrolyte (Aluminum working electrode, lithium counter electrode and lithium reference electrode), according to Example 7.

FIG. 11 shows first cycle differential capacity vs. voltage graph of Li∥graphite half-cells in the 2032 coin cells using 1.2M LiFSI in EMS with 2% VC electrolyte, 1.2M LiFSI in EMS with 2% TFDTD electrolyte, and 1.2M LiFSI in EMS with 2% VC and 2% TFDTD electrolyte (aluminum working electrode, lithium counter electrode and lithium reference electrode), according to Example 8.

FIG. 12 is a discharge capacity vs. cycle number graph for Graphite∥LiNi_{0.8}Mn_{0.1}Co_{0.1}O₂ full-cells in 2032 coin cells using 1.2M LiFSI in EMS with 2% TFDTD electrolyte, 1.2M LiFSI in EMS with 2% TFDTD electrolyte, and 1.2M LiFSI in EMS with 2% TFDTD and 2% LiTFOP electrolyte. The cells were cycled from 3.0 V to 4.5 V at the rate of C/2, according to Example 9.

FIG. 13 is a discharge capacity v. cycle number graph for Graphite∥LiNi_{0.8}Mn_{0.1}Co_{0.1}O₂ full-cells in 2032 coin cells using LiFSI:EMS:FDG 2:4:1 and with 1% TFDTD as the electrolyte, according to Example 10.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

Alkynyl groups are straight chain, branched or cyclic alkyl groups having 2 to about 20 carbon atoms, and further including at least one triple bond. In some embodiments alkynyl groups have from 1 to 12 carbons, or, typically, from 1 to 8 carbon atoms. Alkynyl groups may be substituted or unsubstituted.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Heterocyclyl or heterocycle refers to both aromatic and nonaromatic ring compounds including monocyclic, bicyclic, and polycyclic ring compounds containing 3 or more ring members of which one or more is a heteroatom such as, but not limited to, N, O, and S. Examples of heterocyclyl groups include, but are not limited to: unsaturated 3 to 8 membered rings containing 1 to 4 nitrogen atoms such as, but not limited to pyrrolyl, pyrrolinyl, imidazolyl, pyrazolyl, pyridinyl, dihydropyridinyl, pyrimidinyl, pyrazinyl, pyridazinyl, triazolyl (e.g. 4H-1,2,4-triazolyl, 1H-1,2,3-triazolyl, 2H-1,2,3-triazolyl etc.), tetrazolyl, (e.g. 1H-tetrazolyl, 2H tetrazolyl, etc.); saturated 3 to 8 membered rings containing 1 to 4 nitrogen atoms such as, but not limited to, pyrrolidinyl, imidazolidinyl, piperidinyl, piperazinyl; condensed unsaturated heterocyclic groups containing 1 to 4 nitrogen atoms such as, but not limited to, indolyl, isoindolyl, indolinyl, indolizinyl, benzimidazolyl, quinolyl, isoquinolyl, indazolyl, benzotriazolyl; unsaturated 3 to 8 membered rings containing 1 to 2 oxygen atoms and 1 to 3 nitrogen atoms such as, but not limited to, oxazolyl, isoxazolyl, oxadiazolyl (e.g. 1,2,4-oxadiazolyl, 1,3,4-oxadiazolyl, 1,2,5-oxadiazolyl, etc.); saturated 3 to 8 membered rings containing 1 to 2 oxygen atoms and 1 to 3 nitrogen atoms such as, but not limited to, morpholinyl; unsaturated condensed heterocyclic groups containing 1 to 2 oxygen atoms and 1 to 3 nitrogen atoms, for example, benzoxazolyl, benzoxadiazolyl, benzoxazinyl (e.g. 2H-1,4-benzoxazinyl etc.); unsaturated 3 to 8 membered rings containing 1 to 3 sulfur atoms and 1 to 3 nitrogen atoms such as, but not limited to, thiazolyl, isothiazolyl, thiadiazolyl (e.g. 1,2,3-thiadiazolyl, 1,2,4-thiadiazolyl, 1,3,4-thiadiazolyl, 1,2,5-thiadiazolyl, etc.); saturated 3 to 8 membered rings containing 1 to 2 sulfur atoms and 1 to 3 nitrogen atoms such as, but not limited to, thiazolodinyl; saturated and unsaturated 3 to 8 membered rings containing 1 to 2 sulfur atoms such as, but not limited to, thienyl, dihydrodithiinyl, dihydrodithionyl, tetrahydrothiophene, tetrahydrothiopyran; unsaturated condensed heterocyclic rings containing 1 to 2 sulfur atoms and 1 to 3 nitrogen atoms such as, but not limited to, benzothiazolyl, benzothiadiazolyl, benzothiazinyl (e.g. 2H-1,4-benzothiazinyl, etc.), dihydrobenzothiazinyl (e.g. 2H-3,4-dihydrobenzothiazinyl, etc.), unsaturated 3 to 8 membered rings containing oxygen atoms such as, but not limited to furyl; unsaturated condensed heterocyclic rings containing 1 to 2 oxygen atoms such as benzodioxolyl (e.g., 1,3-benzodioxoyl, etc.); unsaturated 3 to 8 membered rings containing an oxygen atom and 1 to 2 sulfur atoms such as, but not limited to, dihydrooxathiinyl; saturated 3 to 8 membered rings containing 1 to 2 oxygen atoms and 1 to 2 sulfur atoms such as 1,4-oxathiane; unsaturated condensed rings containing 1 to 2 sulfur atoms such as benzothienyl, benzodithiinyl; and unsaturated condensed heterocyclic rings containing an oxygen atom and 1 to 2 oxygen atoms such as benzoxathiinyl. Heterocyclyl group also include those described above in which one or more S atoms in the ring is double-bonded to one or two oxygen atoms (sulfoxides and sulfones). For example, heterocyclyl groups include tetrahydrothiophene oxide and tetrahydrothiophene 1,1-dioxide. Typical heterocyclyl groups contain 5 or 6 ring members. Thus, for example, heterocyclyl groups include morpholinyl, piperazinyl, piperidinyl, pyrrolidinyl, imidazolyl, pyrazolyl, 1,2,3-triazolyl, 1,2,4-triazolyl, tetrazolyl, thiophenyl, thiomorpholinyl, thiomorpholinyl in which the S atom of the thiomorpholinyl is bonded to one or more O atoms, pyrrolyl, pyridinyl homopiperazinyl, oxazolidin-2-onyl, pyrrolidin-2-onyl, oxazolyl, quinuclidinyl, thiazolyl, isoxazolyl, furanyl, dibenzylfuranyl, and tetrahydrofuranyl. Heterocyclyl or heterocycles may be substituted.

In one aspect, described herein is the use of a fluorinated glycol ether co-solvent in organosulfur electrolytes to facilitate the stable cycling of lithium-ion batteries. The viscosity of organosulfur electrolytes is significantly higher than that of conventional electrolyte solvents, such as mixtures of ethylene carbonate and ethylmethylcarbonate. The high viscosity results in a high polarization of the cell using organosulfur electrolytes. Although the viscosity can be lowered with the use of a fluorinated ether as a diluent, the non-solvating nature of common fluorinated ethers such as 1,1,2,2-tetrafluoroethyl-2,2,3,3-tetrafluoropropyl ether (TTE) can reduce the polarity and conductivity of the electrolyte. Herein, we describe the use of fluorinated glycol ethers as a co-solvent for organosulfur electrolytes. Unlike the non-fluorinated counterparts (e.g. diglyme), fluorinated glycol ethers possess enhanced anodic stability. Additionally, compared to common fluorinated ethers that are not able to dissolve any lithium salt, fluorinated glycol ethers, such as 1,1,1-trifluoro-2-(2-(2-(2,2,2-trifluoroethoxy)ethoxy)ethoxy)ethane (FDG), are able to solvate lithium cations due to the presence of the non-fluorinated ethereal oxygen inside the molecule. As a result, the conductivity of sulfone-FDG electrolyte is significantly higher than that of sulfone-TTE electrolytes. With the high anodic stability of fluorinated glycol ether and high safety of organosulfur electrolytes, the new organosulfur-fluorinated glycol ether electrolyte enables exceptionally stable, high voltage cycling of graphite∥LiNi_{0.8}Mn_{0.1}Co_{0.1}O₂ (NMC811) full cells.

As used herein, LiFSI is lithium bis(fluorosulfonyl)amide (Li[N(SO₂F)₂]), EMS is (methylsulfonyl)ethane (CH₂S(O)₂CH₂CH₃), TFPMS is 2,2,3,3-tetrafluoro-1-(methylsulfonyl)butane (CH₃S(O)₂CH₂CF₂CH₂H), FDG is 1,1,1-trifluoro-2-(2-(2-(2,2,2-trifluoroethoxy)ethoxy)ethoxy)ethane (F₃CCH₂(OCH₂CH₂)₂OCH₂CF₃), and DG is diethylene glycol (H₃C(OCH₂CH₂)₂OCH₃).

In one aspect, an electrochemical cell includes a cathode; an anode; and an electrolyte containing a lithium salt, a terminally fluorinated glycol ether, an organosulfur solvent, and, optionally, an electrolyte additive, an aprotic gel polymer, or a mixture thereof. In some embodiments, the terminally fluorinated glycol ether is a short-chain terminally fluorinated glycol ether. In some embodiments, the organosulfur solvent is a fluorinated sulfone or sulfonyl solvent.

Illustrative terminally fluorinated glycol ethers include those represented by Formula I: R¹(O(CH₂)ₘ)ₓ(O(CH₂)ₙ)_{y}OR² (I). In Formula I, R¹ may be a fluorinated alkyl; R² may be a fluorinated alkyl; m and n are each independently 1, 2, or 3; and x and y are independently 0, 1, 2, 3, with the proviso that both x and y are not 0 and x+y≤3. In some embodiments, one of R¹ and R² is a fluorinated alkyl having at least two fluorine atoms. In some embodiments, one of R¹ and R² is a fluorinated alkyl having at least three fluorine atoms.

In some embodiments, R¹ and R² are individually —(CH₂)_{q}(CR⁴R⁵)ₚC(R³)₃; R³, R⁴, and R⁵ are each independently H or F, with the proviso that at least one of R³, R⁴, and R⁵ is F; q is 0, 1, 2, or 3; and p is 0, 1, 2, 3, 4, 5, or 6. In some embodiments, R³ is F; R⁴ and R⁵ are H; q is 1 or 2; and p is 0.

In some embodiments, R¹ and R² are individually —(CH₂)_{q}(CR⁴R⁵)ₚC(R³)₃; R³, R⁴, and R⁵ are each independently H or F, with the proviso that at least one of R³, R⁴, and R⁵ is F; y is 0; x is 2 or 3; q is 0, 1, 2, or 3; p is 0, 1, 2, 3, 4, 5, or 6; and w is 0, 1, 2, 3, 4, 5, or 6. In some embodiments, y is 0; and x is 2 or 3. In some embodiments, R¹ is —(CH₂)_{q}(CH₂)ₚC(R³)₃ where q is 1; p is 0; R³ is F; y is 0; x is 2 or 3; and m is 2.

In some embodiments, m is 1. In some embodiments, m is 2. In some embodiments, m is 3. In some embodiments, n is 1. In some embodiments, n is 2. In some embodiments, n is 3.

In some embodiments, x is 0. In some embodiments, x is 1. In some embodiments, x is 2. In some embodiments, x is 3. In some embodiments, y is 0. In some embodiments, y is 1. In some embodiments, y is 2. In some embodiments, y is 3.

In some embodiments, q is 0. In some embodiments, q is 1. In some embodiments, q is 2. In some embodiments, q is 3. In some embodiments, p is 0. In some embodiments, p is 1. In some embodiments, p is 2. In some embodiments, p is 3. In some embodiments, p is 4. In some embodiments, p is 5. In some embodiments, p is 6.

In some embodiments, R³ is H. In some embodiments, R³ is F. In some embodiments, R⁴ is H. In some embodiments, R⁴ is F. In some embodiments, R⁵ is H. In some embodiments, R⁵ is F.

Illustrative examples of short-chain terminally fluorinated glycol ether(s) include, but are not limited to:

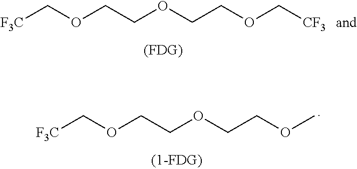 [SMILES: FC(F)(F)COCCOCCOCC(F)(F)F ; "and" ; COCCOCCOCC(F)(F)F]

The organosulfur solvents may be linear or cyclic. Illustrative organosulfur compounds include those represented by Formula (II):

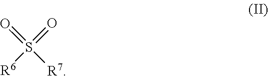

In Formula (II) R⁶ may be H, F, Cl, Br, I, OR⁸, NR⁹R¹⁰, alkyl, alkenyl, alkynyl, silyl, siloxy, aryl, aralkyl, heterocyclyl, heterocyclylalkyl, cycloalkyl, cycloalkylalkyl, —C(O)R¹¹, —C(O)OR¹¹, or —OC(O)R¹¹, wherein any of the alkyl, alkenyl, alkynyl, silyl, siloxy, aryl, aralkyl, heterocyclyl, heterocyclylalkyl, cycloalkyl, and cycloalkylalkyl may be substituted or unsubstituted; R⁷ may be H, F, Cl, Br, I, OR⁸, NR⁹R¹⁰, alkyl, alkenyl, alkynyl, silyl, siloxy, aryl, aralkyl, heterocyclyl, heterocyclylalkyl, cycloalkyl, cycloalkylalkyl, —C(O)R¹¹, —C(O)OR¹¹, or —OC(O)R¹¹, wherein any of the alkyl, alkenyl, alkynyl, silyl, siloxy, aryl, aralkyl, heterocyclyl, heterocyclylalkyl, cycloalkyl, and cycloalkylalkyl may be substituted or unsubstituted; or R⁶ and R⁷ may join together and form a cyclic structure that includes the sulfur atom to which they are bound; R⁸ is H or alkyl; R⁹ is H or alkyl; R¹⁰ is H or alkyl; and R¹¹ is H or alkyl. In some embodiments, R⁶ may be C₁-C₈ alkyl, OR⁸, or NR⁹R¹⁰, and R⁷ may be C₁-C₈ alkyl, OR⁸, or NR⁹R¹⁰. In some embodiments, R⁶ may be C₁-C₈ alkyl, OR⁸, or NR⁹R¹⁰, and R⁷ may be NR⁹R¹⁰.

In some embodiments of Formula (II), R⁶ and R⁷ may join together for form a cyclic structure that includes the sulfur atom to which they are bound. In such embodiments, R⁶ and R⁷ may form a group of formula —OCHR¹¹CH₂O—, wherein R¹¹ is a fluorinated C₁-C₆ alkyl. In some such embodiments, R¹¹ may be —CF₃.

In other embodiments, the organosulfur compound may be represented by the following formulae:

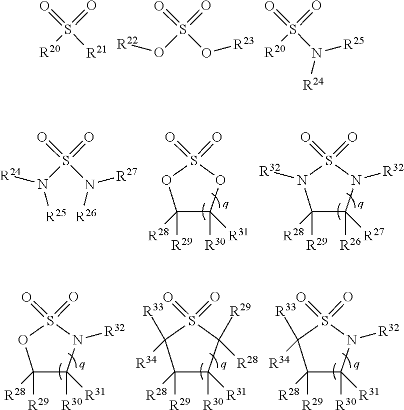

In the above formulae R²⁰ to R³⁴ may be individually H, F, Cl, Br, I, OR³⁵, alkyl, alkenyl, alkynyl, silyl, siloxy, aryl, aralkyl, heterocyclyl, heterocyclylalkyl, cycloalkyl, cycloalkylalkyl, —C(O)R³⁶, —C(O)OR³⁶, or —OC(O)R³⁶; and R³⁵ and R³⁶ may individually be H, alkyl, alkenyl, alkynyl, aryl, aralkyl, or heterocyclyl; and q may be 1 or 2.

In some embodiments of R²⁰ to R³⁴ may be individually H, F, Cl, Br, I, OR³⁵, fluorinated alkyl, fluorinated alkenyl, fluorinated alkynyl, fluorinated silyl, fluorinated siloxy, fluorinated —C(O)R³⁶, fluorinated —C(O)OR³⁶, or fluorinated —OC(O)R³⁶; R³⁵ may be H, fluorinated or non-fluorinated alkyl, fluorinated or non-fluorinated alkenyl, fluorinated or non-fluorinated alkynyl, fluorinated or non-fluorinated aryl, fluorinated or non-fluorinated aralkyl, or fluorinated or non-fluorinated heterocyclyl; R³⁶ may be H, fluorinated or non-fluorinated alkyl, fluorinated or non-fluorinated alkenyl, fluorinated or non-fluorinated alkynyl, fluorinated or non-fluorinated aryl, fluorinated or non-fluorinated aralkyl, or fluorinated or non-fluorinated heterocyclyl.

In another aspect, an electrochemical cell includes a cathode; an anode; a separator; and an electrolyte that includes a lithium salt; a cathode stabilizing additive selected from the group consisting of vinylene carbonate, vinyl ethylene carbonate, LiBF₂(C₂O₄), LiB(C₂O₄)₂, LiPF₂(C₂O₄)₂, LiPF₄(C₂O₄), LiPF₆, LiAsF₆, CsF, CsPF₆, Li₂(B₁₂X₁₂₋ᵢHᵢ), Li₂(B₁₀X_{10-i′}H_{i′}), or a mixture of any two or more thereof, wherein the cathode stabilizing additive is not the same as the lithium salt or the same as an electrolyte stabilizing additive, wherein each X is independently at each occurrence a halogen, i is an integer from 0 to 12 and i′ is an integer from 0 to 10; and a fluorinated organosulfate compound represented by Formula II:

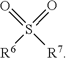

In Formula (II), R⁶ is OR⁸; R⁷ is OR^{8′}; R⁸ is alkyl, alkenyl, alkynyl, aralkyl, or silyl, each of which may be substituted with one or more F; R^{8′} is alkyl, alkenyl, alkynyl, aralkyl, or silyl, each of which may be substituted with one or more F; or R⁸ and R^{8′} join together and form a cyclic structure that includes the sulfur atom; with the proviso that at least one of R⁸ and R^{8′} is substituted with one or more F. In some embodiments, R⁸ and R^{8′} are individually C₁-C₈ alkyl. In other embodiments, R⁸ and R^{8′} form a group of formula —C(R¹²)(R¹³)C(R¹⁴)(R¹⁵)—; R¹², R¹³, R¹⁴, and R¹⁵ are individually H, F, OR¹⁶, alkyl, alkenyl, aralkyl, silyl, an ether, —C(O)OR¹⁶, —OC(O)R¹⁶; each R¹⁶ is H, alkyl, alkenyl, aralkyl; or silyl; or wherein R¹² and R¹³ or R¹⁴ and R¹⁵ join together to form an ═O group; and at least one R¹², R¹³, R¹⁴, and R¹⁵ is fluorine or is a fluorinated group.

In any of the above embodiments, the electrochemical cell may also include a terminally fluorinated glycol ether represented by Formula I:

R¹(O(CH₂)ₘ)ₓ(O(CH₂)ₙ)_{y}OR² (I).

In Formula I, R¹ is a fluorinated alkyl; R² is a fluorinated alkyl; m is 1, 2, or 3; n is 1, 2, or 3; and x and y are each independently 0, 1, or 2, with the provisos that both x and y are not 0 and x+y≤3. In some embodiments, R¹ and R² are individually —(CH₂)_{q}(CR⁴R⁵)ₚC(R³)₃, where R³, R⁴, and R⁵ are each independently H or F, with the proviso that at least one of R³, R⁴, and R⁵ is F; q is 0, 1, 2, or 3; and p is 0, 1, 2, 3, 4, 5, or 6.

In any embodiments herein, and where an alkyl group substituted with fluorine, or a fluorinated alkyl group is described, illustrative examples may include, but are not limited to groups such as: —CFH₂; —CF₂H; —CF₃; —CF₂CF₃; —CF₂CHF₂; —CF₂CH₃; —CF₂CH₂F; —CHFCF₃; —CHFCHF_{2′}, —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂CF₂CF₂CHF₂; —CH₂CF₂CF_{2′}, CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F.

In any embodiments herein, the lithium salt may include a lithium alkyl fluorophosphate; a lithium alkyl fluoroborate; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN)₂; Li[CF₃CO₂]; Li[C₂F₅CO₂]; Li[CH₃SO₃]; Li[N(SO₂CF₃)₂]; Li[N(SO₂F)₂]; Li[C(CF₃SO₂)₃]; Li[N(SO₂C₂F₅)₂]; LiClO₄; LiBF₄; LiAsF₆; LiSbF₆; LiAlCl₄; LiPF₆; LiNO₃; Li₂SO₄; LiOH; Li[BF₂(C₂O₄)]; Li[B(C₂O₄)₂]; Li[PF₂(C₂O₄)₂]; Li[PF₄(C₂O₄)]; LiAsF₆; LiSbF₆; LiNO₃; Li₂(B₁₂X₁₂₋ₚHₚ); Li₂(B₁₀X₁₀₋ₚHₚ); or a mixture of any two or more thereof, wherein X is independently at each occurrence F, Cl, Br, or I, p is 0, 1, 2, 3, 4, 5, 6, 7, 8, 9, 10, 11, or 12, and p′ is 0, 1, 2, 3, 4, 5, 6, 7, 8, 9, or 10. In some embodiments, the salt is LiN(SO₂F)₂. The lithium salt may be present from about 10 wt % to about 50 wt %, based on the total weight of the electrolyte. This may include from about 10 wt % to about 40 wt %, about 10 wt % to about 30 wt %, about 20 wt % to about 50 wt %, about 25 wt % to about 50 wt %, about 30 wt % to about 50 wt %, or about 40 wt % to about 50 wt %.

The electrochemical cells described herein may also include an electrolyte stabilizing additive in the electrolyte. Illustrative electrolyte stabilizing additives include, but are not limited to, LiBF₂(C₂O₄), LiB(C₂O₄)₂, LiPF₂(C₂O₄)₂, LiPF₄(C₂O₄), vinylene carbonate, vinyl ethylene carbonate, γ-butyrolactone, ethylene sulfite, maleic anhydride, succinic anhydride, 1,3-propane sultone, 1,3-propene sultone or a mixture of any two or more thereof, but in any event where the electrolyte stabilizing additive is a lithium salt, it is different from the general lithium salt in the electrolyte In some embodiments, the electrolyte may contain an electrode stabilizing additive that includes LiB(C₂O₄)₂, LiBF₂(C₂O₄)₂, 1,3,2-dioxathiolane-2,2-dioxide, ethylene sulfite, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydropyran, 3,9-diethylidene-2,4,8-trioxaspiro[5,5]undecane, 2-ethylidene-5-vinyl-[1,3]dioxane, anisoles, 2,5-dimethyl-1,4-dimethoxybenzene, 2,3,5,6-tetramethyl-1,4-dimethoxybenzene, 2,5-di-tert-butyl-1,4-dimethoxybenzene, or a mixture of two or more thereof. The electrolyte additive may be present at a concentration of less than about 5 wt %. The electrolyte additive may be present at a concentration of from about 0.01 wt % to about 5 wt %. In some embodiments, the electrolyte additive may be present in the electrolyte at about 0.5 to 1.5 wt %.

In some embodiments, the electrolyte may also include a redox shuttle material. The shuttle, if present, will have an electrochemical potential above the positive electrode's maximum normal operating potential. Illustrative stabilizing agents include, but are not limited to, spirocyclic hydrocarbons containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, lithium alkyl fluorophosphates, lithium alkyl fluoroborates, lithium 4,5-dicyano-2-(trifluoromethyl)imidazole, lithium 4,5-dicyano-2-methylimidazole, trilithium 2,2′,2″-tris(trifluoromethyl)benzotris(imidazolate), Li(CF₃CO₂), Li(C₂F₅CO₂), LiCF₃SO₃, LiCH₃SO₃, LiN(SO₂CF₃)₂, LiC(CF₃SO₂)₃, LiN(SO₂C₂F₅)₂, LiClO₄, LiAsF₆, Li₂(B₁₂X₁₂₋ᵢHᵢ), Li₂(B₁₀X_{10-I′}H_{i′}), wherein X is independently at each occurrence a halogen, I is an integer from 0 to 12 and I′ is an integer from 0 to 10, 1,3,2-dioxathiolane 2,2-dioxide, 4-methyl-1,3,2-dioxathiolane 2,2-dioxide, 4-(trifluoromethyl)-1,3,2-dioxathiolane 2,2-dioxide, 4-fluoro-1,3,2-dioxathiolane 2,2-dioxide, 4,5-difluoro-1,3,2-dioxathiolane 2,2-dioxide, dimethyl sulfate, methyl (2,2,2-trifluoroethyl) sulfate, methyl (trifluoromethyl) sulfate, bis(trifluoromethyl) sulfate, 1,2-oxathiolane 2,2-dioxide, methyl ethanesulfonate, 5-fluoro-1,2-oxathiolane 2,2-dioxide, 5-(trifluoromethyl)-1,2-oxathiolane 2,2-dioxide, 4-fluoro-1,2-oxathiolane 2,2-dioxide, 4-(trifluoromethyl)-1,2-oxathiolane 2,2-dioxide, 3-fluoro-1,2-oxathiolane 2,2-dioxide, 3-(trifluoromethyl)-1,2-oxathiolane 2,2-dioxide, difluoro-1,2-oxathiolane 2,2-dioxide, 5H-1,2-oxathiole 2,2-dioxide, 2,5-dimethyl-1,4-dimethoxybenzene, 2,3,5,6-tetramethyl-1,4-dimethoxybenzene, 2,5-di-tert-butyl-1,4-dimethoxybenzene or a mixture of any two or more thereof, with the proviso that when used, the redox shuttle is not the same as the lithium salt, even though they perform the same function in the cell. That is, for example, if the lithium salt is LiClO₄, it may also perform the dual function of being a redox shuttle, however if a redox shuttle is included in that same cell, it will be a different material than LiClO₄. The electrolyte additive may be present in the electrolyte in an amount of about 1% to about 10% by weight or by volume. This includes an amount of about 1% to about 8% by weight or by volume, about 1% to about 6% by weight or by volume, about 1% to about 4% by weight or by volume, or about 1% to about 3% by weight or by volume. In some embodiments, the electrolyte additive is present in the electrolyte in an amount of about 1, 2, 3, 4, 5, 6, 7, 8, 0.9, or 10% by weight or by volume.

In further embodiments, the electrolyte may further include an aprotic gel polymer. For example, mixtures of poly(ethylene oxide) (PEO) with lithium salts and an organic aprotic solvent may be used.

The electrochemical devices may include an anode which includes, but is not limited to, layered structured materials of graphitic, carbonaceous, oxide or silicon, silicon-carbon composite, phosphorus-carbon composite, tin, tin alloys, silicon alloys, intermetallic compounds, lithium metal, sodium metal, or lithium titanium oxide. The anode may be stabilized by surface coating the active particles with a material. Hence the anodes can also comprise a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The anode may be further stabilized by surface coating the active particles with polymer materials. Examples of polymer coating materials include, but not limited to, polysiloxanes, polyethylene glycol, poly(3,4-ethylenedioxythiophene), polystyrene sulfonate, or a mixture of any two or more polymers.

In some embodiments, the anode of the electrochemical device includes a conductive carbon, natural graphite, synthetic graphite, hard carbon, amorphous carbon, soft carbon, mesocarbon microbeads, acetylene black, Ketjen black, carbon black, mesoporous carbon, porous carbon matrix, carbon nanotube, carbon nanofiber, graphene, silicon microparticle, silicon nanoparticle, silicon-carbon composite, tin microparticle, tin nanoparticle, tin-carbon composite, silicon-tin composite, phosphorous-carbon composites, lithium titanium oxide, lithium metal, sodium metal, lithium titanium oxide, or magnesium metal.

The anode may include lithium metal. This may be present in the form of a foil, sheet, sand, or other metallic form. In some embodiments, the anode includes lithium metal foil. In addition, silicon or conductive carbon materials may be included in the anode. In some embodiments, the conductive carbon is carbon nanotubes, carbon fiber, microporous carbon, mesoporous carbon, macroporous carbon, mesoporous microbeads, graphite, expandable graphite, polymer yield carbon, or carbon black. The metal of the anode may be the current collector, or the anode may also include a current collector.

The cathode material described herein may include oxygen (O₂), in some embodiments. In other embodiments, the cathode may include a metal oxide which may be, but is not limited to, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}E′₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; E′ is Ti, V, Cr, Fe, or Zr; wherein 0≤x≤0.3; 0≤y≤0.5; 0≤z≤0.5; 0≤m≤2; 0≤n≤2; 0≤x′≤0.4; 0α≤1; 0≤β1; 0≤γ≤1; 0h≤1; 0k≤1; 0≤l≤1; 0≤y′≤0.4; 0≤z′≤0.4; and 0≤x″≤3; with the proviso that at least one of h, k and l is greater than 0. In some embodiments, the metal oxide includes Li_{i+w}MnₓNi_{y}Co_{z}O₂ wherein w, x, y, and z satisfy the relations 0<w<1, 0≤x<1, 0≤y<1, 0≤z<1, and x+y+z=1. In some embodiments, the metal oxide includes LiMnₓNi_{y}O₄ wherein x and y satisfy the 0≤x<2, 0≤y<2, and x+y=2. In some embodiments, the positive electrode includes LiMnₓNi_{y}O₄ wherein x and y satisfy the 0≤x<2, 0≤y<2, and x+y=2. In some embodiments, the positive electrode includes xLi₂MnO₃·(1-x)LiMO₂ is wherein 0≤x<2. In some embodiments, the cathode includes a metal oxide that is LiMn_{0.5}Ni_{0.5}O₂, LiCoO₂, LiNiO₂, LiNi₁₋ₓCo_{y}Mn_{z}O₂, or a combination of any two or more thereof. In one embodiment, the cathode includes a metal oxide that is LiCoO₂ (lithium cobalt oxide). In one embodiment, the cathode includes a metal oxide that is LiFePO₄ (lithium iron phosphate oxide (LFP)). In some embodiments, the metal oxide is a lithium nickel manganese cobalt oxide (NMC). For example, the cathode may include a metal oxide that is LiNi_{α}Mn_{β}Co_{γ}O₂, NMC111 (LiNi_{0.33}Co_{0.33}Mn_{0.33}O₂), NMC532 (LiNi_{0.5}Co_{0.2}Mn_{0.3}O₂), NMC622 (LiNi_{0.6}Co_{0.2}Mn_{0.2}O₂), NMC811 (LiNi_{0.8}Co_{0.1}Mn_{0.1}O₂) or a Ni-rich layer material such as Li_{1+x′}NiₕMnₖCoₗMe²_{y′}O_{2-z′}F_{z′} where 0≤h≤1. In some embodiments, the cathode comprises LiMn_{0.5}Ni_{0.5}O₂, LiCoO₂, LiNiO₂, LiNi₁₋ₓCo_{y}Mn_{z}O₂, or a combination of any two or more thereof, wherein 0≤x≤0.3; 0≤y≤0.5; 0≤z≤0.5.

The term “spinel” refers to a manganese-based spinel such as, Liᵢ₊ₓMn_{2-y}Me_{z}O₄₋ₕAₖ, wherein Me is Al, Mg, Ti, B, Ga, Si, Ni, or Co; A is S or F; and wherein 0≤x≤0.5, 0≤y≤0.5, 0≤z≤0.5, 0≤h≤0.5, and 0≤k≤0.5.

The term “olivine” refers to an iron-based olivine such as, LiFe₁₋ₓMe_{y}PO₄₋ₕAₖ, wherein Me is Al, Mg, Ti, B, Ga, Si, Ni, or Co; A is S or F; and wherein 0≤x≤0.5, 0≤y≤0.5, 0≤h≤0.5, and 0≤k≤0.5.

The cathode may be further stabilized by surface coating the active particles with a material that can neutralize acid or otherwise lessen or prevent leaching of the transition metal ions. Hence, the cathodes may also include a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The coating can be applied to a carbon-coated cathode.

The cathode may be further stabilized by surface coating the active particles with polymer materials. Examples of polymer coating materials include, but not limited to, polysiloxanes, polyethylene glycol, or poly(3,4-ethylenedioxythiophene), polystyrene sulfonate, a mixture of any two or more polymers.

The electrodes of the electrochemical cells (i.e. the lithium batteries) may also include a current collector. Current collectors for either the anode or the cathode may include those of copper, stainless steel, titanium, tantalum, platinum, gold, aluminum, nickel, cobalt, cobalt nickel alloy, highly alloyed ferritic stainless steel containing molybdenum and chromium; or nickel-, chromium-, or molybdenum containing alloys.

The electrodes (i.e., the cathode and/or the anode) may also include a conductive polymer as a binder. Illustrative conductive polymers include, but not limited to, polyaniline, polypyrrole, poly(pyrrole-co-aniline), polyphenylene, polythiophene, polyacetylene, polysiloxane, polyvinylidene difluoride, or polyfluorene.

The electrochemical cells disclosed herein may also include a porous separator to separate the cathode from the anode and prevent, or at least minimize, short-circuiting in the device. The separator may be a polymer or ceramic or mixed separator. The separator may include, but is not limited to, polypropylene (PP), polyethylene (PE), trilayer (PP/PE/PP), or polymer films that may optionally be coated with alumina-based ceramic particles.

As an example of the electrochemical cells described herein are lithium secondary batteries. The lithium secondary batteries described herein may find application as a lithium battery or a lithium-air battery.

The present invention, thus generally described, will be understood more readily by reference to the following examples, which are provided by way of illustration and are not intended to be limiting of the present invention.

### EXAMPLES

Example 1. 2032 coin cells of Gr (graphite)∥NMC811 (LiNi_{0.5}Mn_{0.1}Co_{0.1}O₂) were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included lithium bis(fluoromethanesulfonyl)imide (LiFSI) dissolved in ethyl methyl sulfone (EMS) and diglyme (DG) in a LiFSI:EMS:DG molar ratio of 2:4:1 (Cell A); LiFSI dissolved in ethyl methyl sulfone (EMS) and diglyme (DG) in a LiFSI:EMS:FDG molar ratio of 2:4:1 (Cell B); as well as LiFSI dissolved in ethyl methyl sulfone (EMS) and diglyme (DG) in a LiFSI:EMS:TTE molar ratio of 2:4:1 (Cell C).

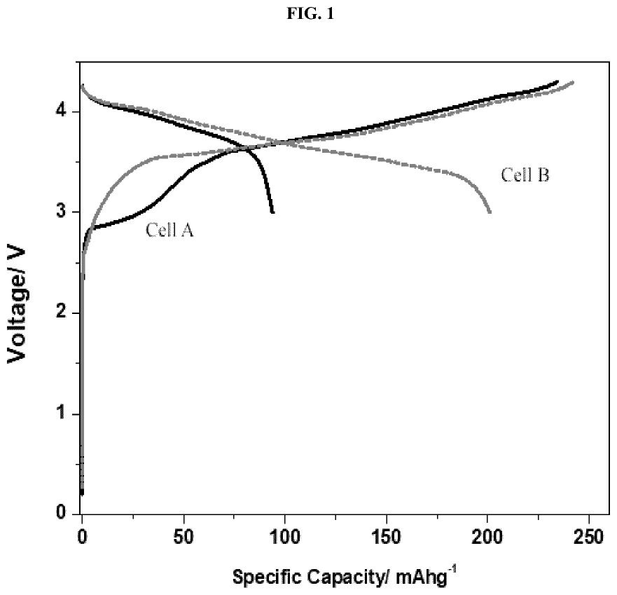

The 1^{st}-cycle voltage profiles of the 2032 coin cells of this example, are shown in FIG. 1 for Cells A and B. Cell A displayed much lower discharge capacity than Cell B due to the anodic instability of DG (regular glycol ether), which began to decompose at around 3V as shown in the charging curve. There is no decomposition plateau between 3.0 V to 4.25 V for Cell B, suggesting that FDG (terminally fluorinated glycol ether) is oxidatively significantly more stable than regular glycol ether.

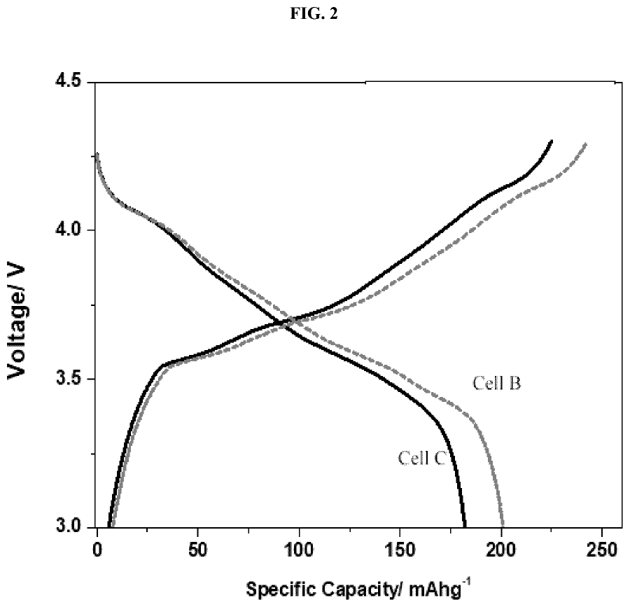

The 1^{st}-cycle voltage profiles of the 2032 coin cells of this example are shown in FIG. 2 for Cells B and C. There is no decomposition plateau between 3.0 V to 4.25 V for Cell C, suggesting that TTE (fluorinated mono-ether) is also oxidatively stable. However, a significantly larger polarization was observed for Cell C compared to Cell B, demonstrating the stronger solvating ability of FDG, which leads to higher electrolyte conductivity and lower cell impedance.

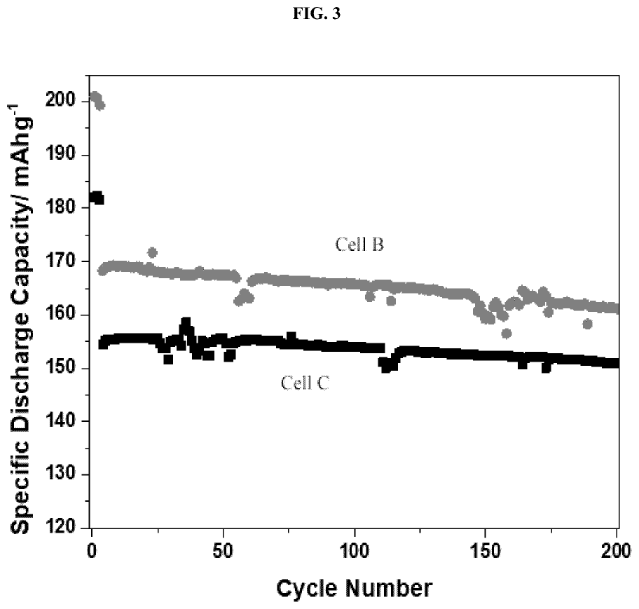

Coin cells B and C were cycled between 3.0 V to 4.25 V. As depicted in FIG. 3, the cycling performance of the Gr∥NMC811 cells illustrates that both Cell B and Cell C displayed similar capacity retention. However, the initial capacity of Cell C was only 155 mAh/g, while the initial capacity of Cell B was significantly higher at 170 mAh/g, due to the enhanced conductivity of the FDG electrolyte.

Example 2. 2032 coin cells of Gr (graphite)∥NMC811 (LiNi_{0.8}Mn_{0.1}Co_{0.1}O₂) were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included lithium bis(fluoromethanesulfonyl)imide (LiFSI) dissolved in ethyl methyl sulfone (EMS) in a LiFSI:EMS molar ratio of 1:4 (Cell D); LiFSI dissolved in 1,1,2,2-tetrafluoro-3-(methylsulfonyl)propane (TFPMS) in a LiFSI:TFPMS molar ratio of 1:4 (Cell E).

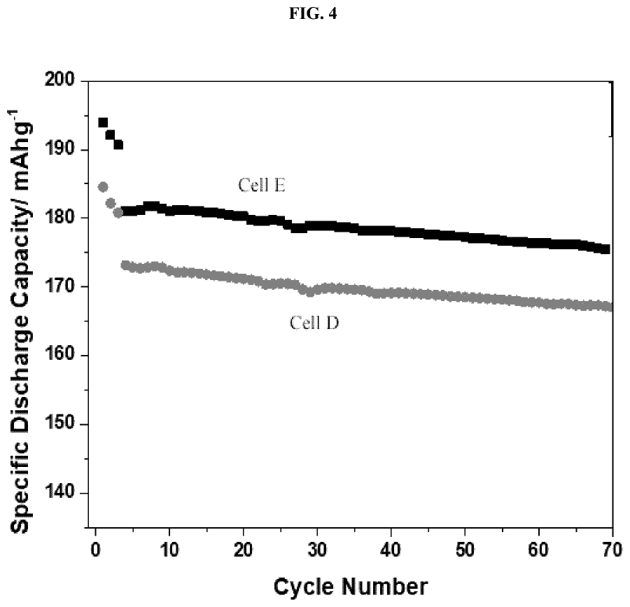

The coin cells (Cell D and Cell E) were cycled between 3.0 V to 4.25 V. As depicted in FIG. 4, the cycling performance of the Gr∥NMC811 cells illustrates that both Cell B and Cell C displayed similar capacity retention. However, the initial capacity of Cell D was only 173 mAh/g, while the initial capacity of Cell B was significantly higher at 181 mAh/g, due to the formation of more robust SEI with TFPMS based electrolyte.

Example 3. 2032 coin cells of Gr (graphite)∥NMC811 (LiNi_{0.8}Mn_{0.1}Co_{0.1}O₂) were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included LiFSI dissolved in TFPMS and TTE in a LiFSI:TFPMS:TTE molar ratio of 1:4:2 (Cell F); LiFSI dissolved in TFPMS and FDG in a LiFSI:TFPMS:FDG molar ratio of 1:4:2 (Cell G).

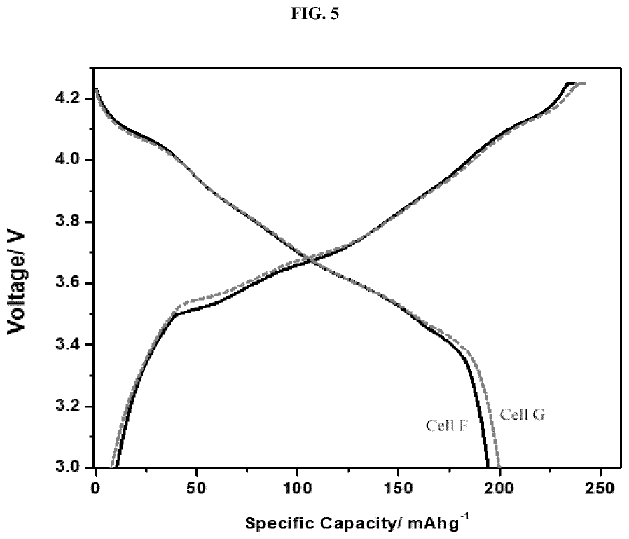

The 1^{st}-cycle voltage profiles (FIG. 5) of the 2032 coin cells of Gr∥NMC811 (LiNi_{0.5}Mn_{0.1}Co_{0.1}O₂) in Example 1 are shown for Cells F and G. A significantly larger polarization was observed for Cell F compared to Cell G, suggesting the stronger solvating ability of FDG, which leads to higher electrolyte conductivity and lower cell impedance.

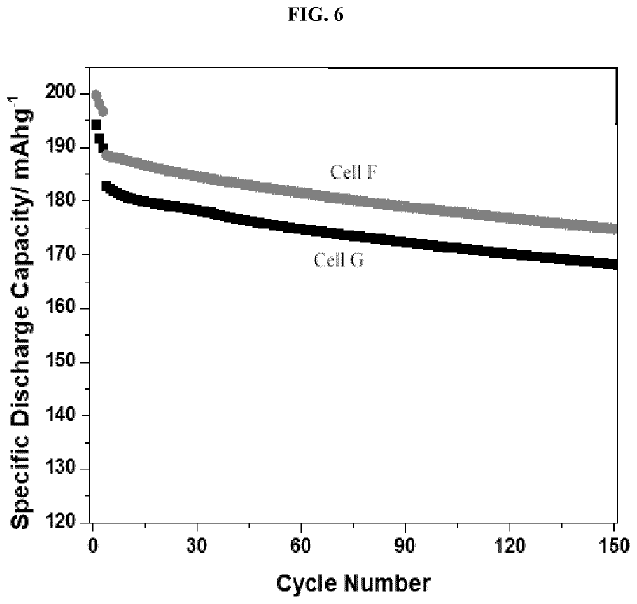

The coin cells (Cell F and Cell G) were cycled between 3.0 V to 4.25 V. As depicted in FIG. 6, the cycling performance of the Gr∥NMC811 cells illustrates that both Cell F and Cell G displayed similar capacity retention. However, the initial capacity of Cell F was only 183 mAh/g, while the initial capacity of Cell G was significantly higher at 190 mAh/g. This is because firstly, a more robust SEI was formed by TFPMS based electrolyte, and secondly, the stronger solvating ability of FDG leads to higher electrolyte conductivity and lower cell impedance.

Example 4. 2032 coin cells of Gr (graphite)∥NMC811 were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included 1.2M lithium bis(fluoromethanesulfonyl)-imide (LiFSI) dissolved in ethyl methyl sulfone (EMS) electrolyte (Cell H); 1.2M LiFSI dissolved in tetramethylene sulfone (TMS) electrolyte (Cell I).

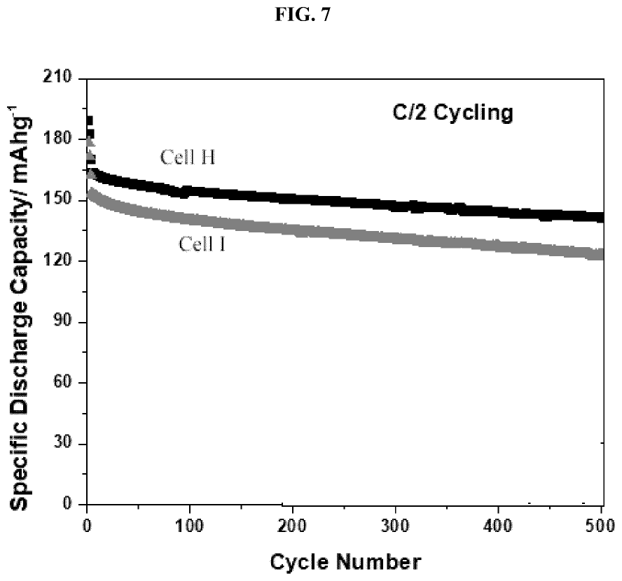

The coin cells (Cell H and Cell I) were cycled between 3.0 V to 4.5 V. As depicted in FIG. 7, the cycling performance of the Gr∥NMC811 cells illustrates that Cell H displays significantly higher capacity and better capacity retention than Cell I. However, the initial capacity of Cell H was only 175 mAh/g, which is still significantly lower than the Gr∥NMC811 cell using conventional electrolyte.

Example 5. 2032 coin cells of Gr∥NMC811 were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included 1.2M LiFSI dissolved in EMS electrolyte with 2% vinylene carbonate (VC) electrolyte (Cell J); 1.2M LiFSI dissolved in EMS electrolyte with 2% 4-(trifluoromethyl)-1,3,2-dioxathiolane 2,2-dioxide (TFDTD) electrolyte (Cell K); 1.2M LiFSI dissolved in EMS electrolyte with 2% 1,3,2-dioxathiolane 2,2-dioxide (DTD) electrolyte (Cell L). For clarity, the structures of TFDTD and DTD used are:

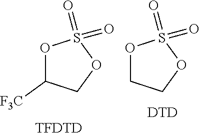

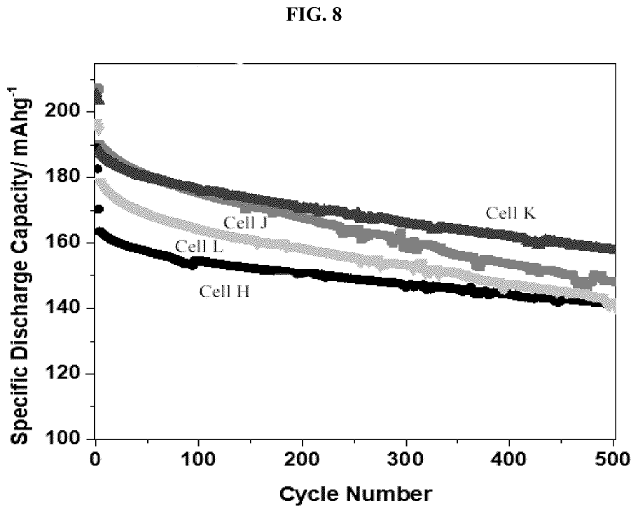

The coin cells (Cell J, Cell K, and Cell L) were cycled between 3.0 V to 4.5 V. As depicted in FIG. 8, the cycling performance of the Gr∥NMC811 cells illustrates that all cells with additives (Cell J, Cell K, and Cell L) displayed improved capacity compared to Cell H (No additive). Both Cell J and Cell K displayed higher capacity than Cell H, while the capacity retention of Cell K is significantly better than that of Cell J, suggesting TFDTD is a better additive than VC or DTD.

Example 6. 2032 coin cells of Gr (graphite)∥NMC811 (LiNi_{0.5}Mn_{0.1}Co_{0.1}O₂) were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included 1.2M lithium hexafluorophosphate (LiPF₆) in ethylene carbonate (EC) and ethyl methyl carbonate (EMC) in a weight ratio of 3:7 electrolyte (Cell M), 1.2M LiFSI in EMS with 2% TFDTD and 2% VC electrolyte (Cell N).

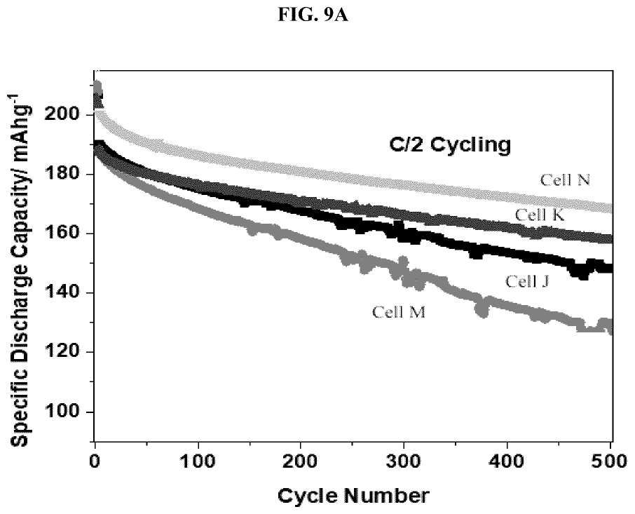

The coin cells (Cells J, K, M, and N) were cycled between 3.0 V to 4.5 V. As depicted in FIG. 9A, all Gr∥NMC811 full cells using organosulfur based electrolyte with additive displayed enhanced cycling performance than the full cell using conventional carbonate electrolyte (Cell M). Cell N presented the best initial capacity and the best capacity retention, suggesting the use of dual additives TFDTD and VC generated significant synergistic effect. As depicted in FIG. 9B, Cell B showed a significantly higher average Coulombic efficiency than both Cell J and Cell K, further supporting the synergistic effect of dual additives TFDTD and VC in organosulfur based electrolyte.

Example 7. 2032 coin cells of Lithium (Li)∥Aluminum (Al) were prepared with an aluminum positive electrode, a lithium anode, a glass fiber separator, and the prepared electrolyte (50 μL in each cell). The Li∥Al cells were prepared in an argon atmosphere glovebox (<1 ppm of O₂ and H₂O). The electrolytes included 1.2M LiFSI in EMS electrolyte (Cell O); 1.2M LiFSI in EMS with 2% TFDTD electrolyte (Cell P); 1.2M LiFSI in EMS with 2% VC electrolyte (Cell Q).

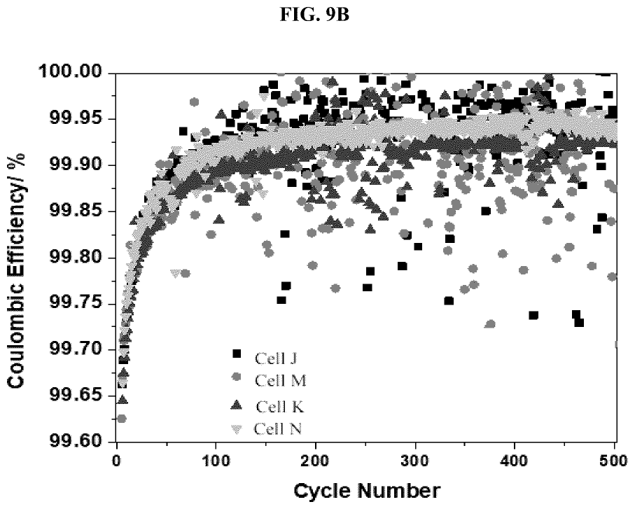

FIG. 10 presents the linear sweep voltammetry (LSV) of Cells O, P, and Q. The onset oxidation potential of Cell H and Cell I was almost the same, suggesting that the addition of TFDTD into the EMS electrolyte did not change the oxidation potential of the electrolyte. However, the onset oxidation potential of Cell Q is lower than that of Cell P, suggesting that VC oxidizes preferentially to EMS and is able to form protecting film on the cathode surface.

Example 8. 2032 coin cells of Li∥Graphite (Gr) were prepared with graphite positive electrode (1.84 mAh cm⁻² areal capacity), a lithium anode, a glass fiber separator, and the prepared electrolyte (50 μL in each cell). The Li∥Gr cells were prepared in an argon atmosphere glovebox (<1 ppm of O₂ and H₂O). The electrolytes included 1.2M LiFSI in EMS with 2% TFDTD electrolyte (Cell R); 1.2M LiFSI in EMS with 2% VC electrolyte (Cell S); 1.2M LiFSI in EMS with 2% TFDTD and 2% VC electrolyte (Cell T).

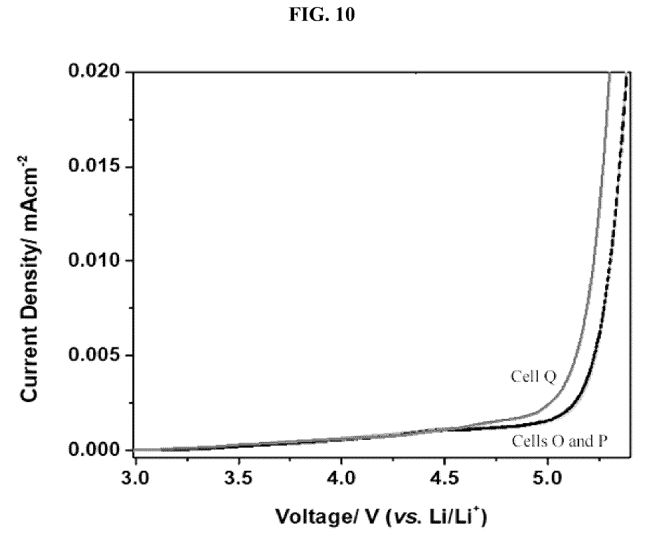

The coin cells were cycled between 0.01 V to 1.5 V. As depicted in FIG. 11, the differential capacity of the Li∥Gr cells illustrates that VC reduces at around 0.6 V while TFDTD reduces at around 1.1 V. For the dual additives cell (Cell T), only TFDTD reduction was observed, suggesting TFDTD was preferentially reduced on graphite anode and stop VC from further reduction.

Example 9. 2032 coin cells of Gr∥NMC811 were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included 1.2M LiFSI in EMS with 2% lithium tetrafluoro oxalato phosphate (LiTFOP) electrolyte (Cell U); 1.2M LiFSI in EMS with 2% TFDTD electrolyte (Cell V); 1.2M LiFSI in EMS with 2% LiTFOP and 2% TFDTD electrolyte (Cell W). For clarity, the structure of LiTFOP used is:

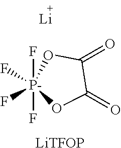

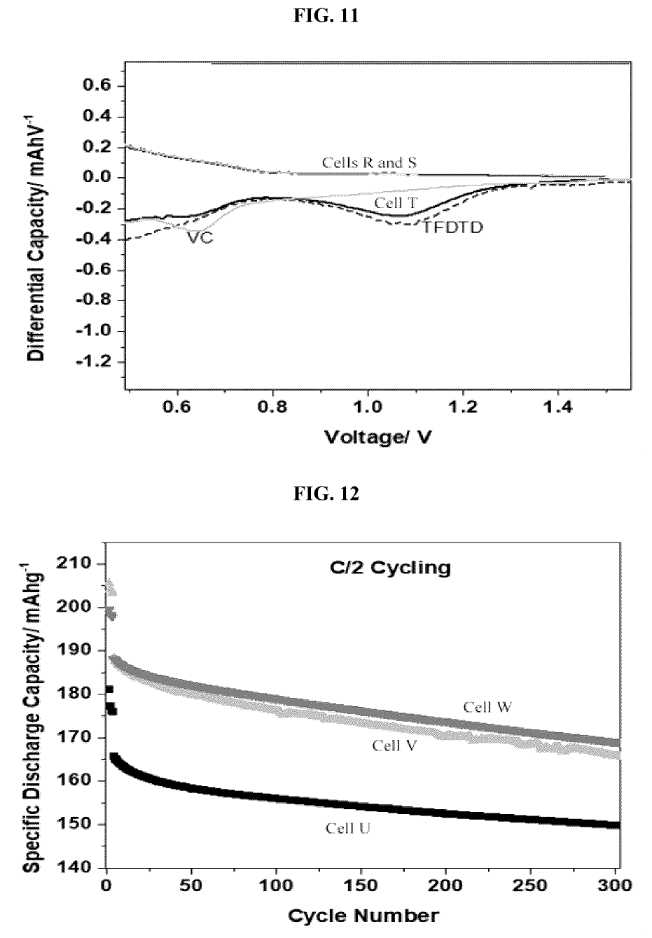

The coin cells were cycled between 3.0 V to 4.5 V. As depicted in FIG. 12, the cycling performance of Gr∥NMC811 full cell (Cell U) using only LiTFOP additive displayed relatively low (165 mAh/g) initial capacity, suggesting that LiTFOP was not able to form robust solid-electrolyte interphase (SEI) on the graphite anode. However, Gr∥NMC811 full cell (Cell W) using dual additives LiTFOP and TFDTD presented better initial capacity and capacity retention than the full cell (Cell V) using only TFDTD additive, suggesting there was synergistic effect between TFDTD, which is an anode additive, and LiTFOP, which is a cathode additive.

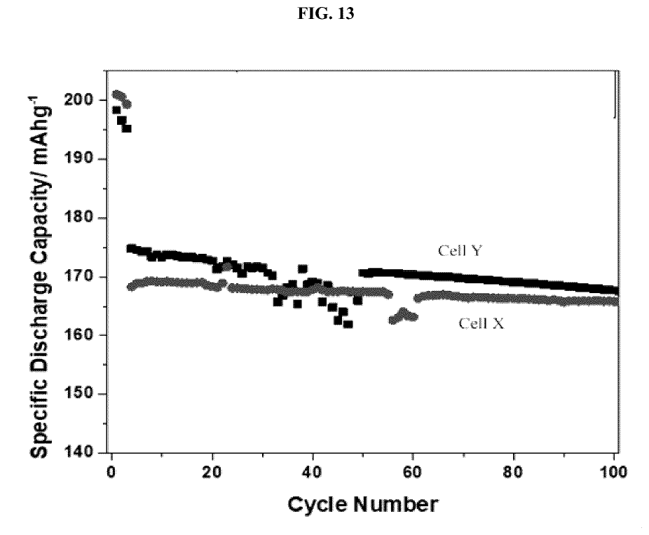

Example 10. 2032 coin cells of Gr∥NMC811 were prepared with an NMC811 positive electrode (1.43 mAh cm⁻² areal capacity), a graphite anode (1.84 mAh cm⁻² areal capacity), a glass fiber separator, and the prepared electrolyte (50 μL in each cell). The Gr∥NMC811 cells were prepared in an argon atmosphere glovebox (<1 ppm of O₂ and H₂O). The electrolytes included LiFSI in EMS and FDG at a ratio of 2:4:1 (Cell X) and with 1% TFDTD (Cell Y). As shown in FIG. 13, Cells X and Y were cycled at 3-4.3V, with cell YR displaying an enhanced capacity compared to Cell Y. FIG. 13 illustrate the further increase in capacity with the addition of 1% TFDTD.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
a cathode comprising a cathode active material;
an anode comprising an anode active material; and
an electrolyte comprising a sulfonyl solvent, a terminally fluorinated glycol ether, and a salt.

2. The electrochemical cell of claim 1, wherein the terminally fluorinated glycol ether is represented by Formula I:
R¹(O(CH₂)ₘ)ₓ(O(CH₂)ₙ)_{y}OR² (I)
wherein:
R¹ is a fluorinated alkyl;
R² is a fluorinated alkyl;
m is 1, 2, or 3;
n is 1, 2, or 3; and
x and y are each independently 0, 1, or 2, with the provisos that both x and y are not 0 and x+y≤3.

3. The electrochemical cell of claim 2, wherein:
R¹ and R² are individually —(CH₂)_{q}(CR⁴R⁵)ₚC(R³)₃;
R³, R⁴, and R⁵ are each independently H or F, with the proviso that at least one of R³, R⁴, and R⁵ is F;
q is 0, 1, 2, or 3; and
p is 0, 1, 2, 3, 4, 5, or 6.

4. The electrochemical cell of claim 3, wherein R³ is F; R⁴ and R⁵ are individually H or F; q is 1 or 2; and p is 0.

5. The electrochemical cell of claim 3, wherein y is 0 and x is 2 or 3.

6. The electrochemical cell of claim 2, wherein R¹ and R² are —CH₂CF₃, m is 2, x is 2, y is 0.

7. The electrochemical cell of claim 1, wherein the sulfonyl solvent comprises a compound represented by Formula (II): 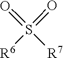
wherein:
R⁶ is H, F, Cl, Br, I, OR⁸, NR⁹R¹⁰, alkyl, alkenyl, alkynyl, silyl, siloxy, aryl, aralkyl, heterocyclyl, heterocyclylalkyl, cycloalkyl, cycloalkylalkyl, —C(O)R¹¹, —C(O)OR¹¹, or —OC(O)R¹¹, wherein any of the alkyl, alkenyl, alkynyl, silyl, siloxy, aryl, aralkyl, heterocyclyl, heterocyclylalkyl, cycloalkyl, and cycloalkylalkyl may be substituted or unsubstituted;
R⁷ is H, F, Cl, Br, I, OR⁸, NR⁹R¹⁰, alkyl, alkenyl, alkynyl, silyl, siloxy, aryl, aralkyl, heterocyclyl, heterocyclylalkyl, cycloalkyl, cycloalkylalkyl, —C(O)R¹¹, —C(O)OR¹¹, or —OC(O)R¹¹, wherein any of the alkyl, alkenyl, alkynyl, silyl, siloxy, aryl, aralkyl, heterocyclyl, heterocyclylalkyl, cycloalkyl, and cycloalkylalkyl may be substituted or unsubstituted;
or R⁶ and R⁷ join together and form a cyclic structure that includes the sulfur atom to which they are bound;
R⁸ is H or alkyl;
R⁹ is H or alkyl;
R¹⁰ is H or alkyl; and
R¹¹ is H or alkyl.

8. The electrochemical cell of claim 7, wherein R⁶ is C₁-C₈ alkyl, OR⁸, or NR⁹R¹⁰, and R⁷ is C₁-C₈ alkyl, OR⁸, or NR⁹R¹⁰.

9. The electrochemical cell of claim 7, wherein R⁶ is C₁-C₈ alkyl, OR⁸, or NR⁹R¹⁰, and R⁷ is NR⁹R¹⁰.

10. The electrochemical cell of claim 9, wherein R⁶ and R⁷ join together for form a cyclic structure that includes the sulfur atom to which they are bound.

11. The electrochemical cell of claim 9, wherein R⁶ and R⁷ form a group of formula —OCHR¹¹CH₂O—, wherein R¹¹ is a fluorinated C₁-C₆ alkyl.

12. The electrochemical cell of claim 11, wherein R¹¹ is —CF₃.

13. The electrochemical device of claim 1, wherein the cathode comprises sulfur, carbon coated sulfur, sulfurized polyacrylonitrile, a spinel, an olivine, a carbon-coated olivine, LiMn_{0.5}Ni_{0.5}O₂, LiCOO₂, LiNiO₂, LiNi₁₋ₓCo_{y}Me_{z}O₂, LiNi_{α}Mn_{β}CO_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂, or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the provisos that at least one of h, k and l is greater than 0, and at least one of x, y and z is greater than 0.

14. The electrochemical device of claim 1, wherein the salt comprises a lithium alkyl fluorophosphate; a lithium alkyl fluoroborate; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN)₂; Li[CF₃CO₂]; Li[C₂F₅CO₂]; Li[CH₃SO₃]; Li[N(SO₂CF₃)₂]; Li[N(SO₂F)₂]; Li[C(CF₃SO₂)₃]; Li[N(SO₂C₂F₅)₂]; LiClO₄; LiBF₄; LiAsF₆; LiSbF₆; LiAlCl₄; LiPF₆; LiNO₃; Li₂SO₄; LiOH; Li[BF₂(C₂O₄)]; Li[B(C₂O₄)₂]; Li[PF₂(C₂O₄)₂]; Li[PF₄(C₂O₄)]; LiAsF₆; LiSbF₆; LiNO₃; Li₂(B₁₂X₁₂₋ₚHₚ); Li₂(B₁₀X₁₀₋ₚHₚ); or a mixture of any two or more thereof, wherein X is independently at each occurrence F, Cl, Br, or I, p is 0, 1, 2, 3, 4, 5, 6, 7, 8, 9, 10, 11, or 12, and p′ is 0, 1, 2, 3, 4, 5, 6, 7, 8, 9, or 10.

15. The electrochemical cell of claim 1, wherein the salt comprises LiN(SO₂F)₂.

16. The electrochemical cell of claim 1 that is free of carbonate solvents, lactone solvents, and non-fluorinated ethers.

17. The electrochemical cell of claim 1, wherein the sulfonyl solvent and the terminally fluorinated glycol ether are present in the electrolyte in a ratio of from about 5:1 to about 2:1.

18. The electrochemical cell of claim 1, wherein the salt, sulfonyl solvent, and terminally fluorinated glycol ether are present in the electrolyte in a ratio of about 2:4:1.

19. An electrochemical cell comprising:
a cathode;
an anode;
a separator; and
an electrolyte comprising:
a lithium salt;
a cathode stabilizing additive selected from the group consisting of vinylene carbonate, vinyl ethylene carbonate, LiBF₂(C₂O₄), LiB(C₂O₄)₂, LiPF₂(C₂O₄)₂, LiPF₄(C₂O₄), LiPF₆, LiAsF₆, CsF, CsPF₆, Li₂(B₁₂X₁₂₋ᵢHᵢ), Li₂(B₁₀X_{10-i′}H_{i′}), or a mixture of any two or more thereof, wherein the cathode stabilizing additive is not the same as the lithium salt, wherein each X is independently at each occurrence a halogen, i is an integer from 0 to 12 and i′ is an integer from 0 to 10; and
a fluorinated organosulfate compound represented by Formula II: 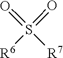
wherein:
R⁶ is OR⁸;
R⁷ is OR^{8′};
R⁸ is alkyl, alkenyl, alkynyl, aralkyl, or silyl, each of which may be substituted with one or more F;
R^{8′} is alkyl, alkenyl, alkynyl, aralkyl, or silyl, each of which may be substituted with one or more F;
or R⁸ and R^{8′} join together and form a cyclic structure that includes the sulfur atom;
with the proviso that at least one of R⁸ and R^{8′} is substituted with one or more F.

20. The electrochemical cell of claim 19 further comprising a terminally fluorinated glycol ether represented by Formula I:
R¹(O(CH₂)ₘ)ₓ(O(CH₂)ₙ)_{y}OR² (I)
wherein:
R¹ is a fluorinated alkyl;
R² is a fluorinated alkyl;
m is 1, 2, or 3; and
x and y are each independently 0, 1, or 2, with the provisos that both x and y are not 0 and x+y≤3.
